(19) United States
(12) Patent Application Publication
(10) Pub. No.: US 2007/0120747 A1
(43) Pub. Date: May 31, 2007

(54) High performance retractable half-wave antenna

(75) Inventors: Alejandro Candal, Davie, FL (US); Julio C. Castaneda, Coral Springs, FL (US); Jose M. Gonzalez, Pembroke Pines, FL (US); Lorenzo A. Ponce De Leon, Lake Worth, FL (US); Francis M. Staszesky, Fort Lauderdale, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/290,195

(22) Filed: Nov. 30, 2005

(51) Int. Cl. H01Q 1/24; H01Q 1/36

(52) U.S. Cl. 343/702; 343/895

(57) ABSTRACT

An antenna (100) that includes a first helical radiator (102) and a second helical radiator (116) positioned substantially co-linear with the first helical radiator. The first helical radiator can be communicatively linked to a signal source (106). The second helical radiator can be moveable between a first position wherein the second helical radiator is substantially adjacent to the first helical radiator and a second position wherein the second helical radiator is distal from the first helical radiator. The first helical radiator and the second helical radiator can cooperate to transmit and/or receive electromagnetic signals using an electrical connection and/or electromagnetic coupling. The electromagnetic coupling can primarily include capacitive coupling. The antenna also can include an impedance tuning member (538) which electromagnetically couples to the first helical radiator and/or the second helical radiator.

### BACKGROUND OF THE INVENTION

1. Field of the Invention

The present invention generally relates to antennas and, more particularly, to retractable antennas.

2. Background of the Invention

In response to consumer demand, new mobile communication devices continue to be developed which are dimensionally smaller than previous models. For example, some communication devices that are now being developed are significantly shorter and thinner than models that they will replace. Such devices can be easily carried in one's pocket, making their use convenient.

Unfortunately, making a mobile communication device dimensionally smaller creates challenges for the RF engineer. In particular, as antennas for the devices become smaller, engineers are forced to operate the antennas in quarter-wave mode. With all other parameters being equal, the specific absorption rate (SAR) of an antenna in quarter-wave mode is typically higher than the SAR of an antenna operating in half-wave mode.

### SUMMARY OF THE INVENTION

The present invention relates to an antenna that includes a first helical radiator and a second helical radiator positioned substantially collinear with the first helical radiator. The second helical radiator can be moveable between a first position wherein the second helical radiator is substantially adjacent to the first helical radiator and a second position wherein the second helical radiator is distal from the first helical radiator. The first helical radiator and the second helical radiator can cooperate to transmit and/or receive electromagnetic signals using an electrical connection and/or electromagnetic coupling. The electromagnetic coupling can primarily include capacitive coupling. The antenna also can include an impedance tuning member which electromagnetically couples to the first helical radiator and/or the second helical radiator.

The first helical radiator can be communicatively linked to a signal source. In one arrangement, the first helical radiator can be communicatively linked to the signal source when the second helical radiator is in the first position and not communicatively lined to the signal source when the second helical radiator is in the second position.

The antenna can include a whip to which the second helical radiator is attached. The whip can, for example, electrically connect the second helical radiator to the first helical radiator. For instance, the second helical radiator can be electrically connected to the first helical radiator when the second helical radiator is in the first position and electrically connected to the first helical radiator when the second helical radiator is in the second position. In another arrangement, the second helical radiator can be electromagnetically coupled to the first helical radiator when the second helical radiator is in the first position, and electrically connected to the first helical radiator when the second helical radiator is in the second position.

The present invention also relates to a method for tuning performance characteristics of an antenna. The method can include positioning a second helical radiator substantially collinear with a first helical radiator such that the second helical radiator is moveable between a first position wherein the second helical radiator is substantially adjacent to the first helical radiator, and a second position wherein the second helical radiator is distal from the first helical radiator. The first helical radiator and the second helical radiator can cooperate to transmit and/or receive electromagnetic signals using an electrical connection and/or electromagnetic coupling. For example, the method can include capacitively coupling the second helical radiator to the first helical radiator when the second helical radiator is in a first position.

The method also can include communicatively linking the first helical radiator to a signal source. In one arrangement, the second helical radiator can be communicatively linked to the signal source when the second helical radiator is in the first position and communicatively linked to the signal source when the second helical radiator is in the second position. In another arrangement, the second helical radiator is not communicatively linked to the signal source when the second helical radiator is in a first position, but can be communicatively linked to the signal source when the second helical radiator is in a second position.

### BRIEF DESCRIPTION OF THE DRAWINGS

Preferred embodiments of the present invention will be described below in more detail, with reference to the accompanying drawings, in which:

FIG. 1 depicts a retractable antenna that is useful for understanding the present invention.

FIG. 2 depicts the antenna of FIG. 1 in an extended position.

FIG. 3 depicts another arrangement of the antenna that is useful for understanding the present invention.

FIG. 4 depicts the antenna of FIG. 3 in an extended position.

FIG. 5 depicts another arrangement of the antenna that is useful for understanding the present invention.

FIG. 6 depicts the antenna of FIG. 5 in an extended position.

FIG. 7 depicts yet another arrangement of the antenna that is useful for understanding the present invention.

FIG. 8 depicts the antenna of FIG. 7 in an extended position.

FIG. 9 is a flowchart useful for understanding the present invention.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a high performance retractable half-wave antenna. More particularly, the antenna of the present invention achieves a low specific absorption ratio (SAR) and transmit/receive efficiencies that are higher than a quarter-wave retracted antenna of similar size. These performance specifications are achieved while the antenna is operated in both an extended position and, importantly, when operated in a retracted position. Accordingly, the antenna can efficiently transmit and receive RF signals even though the antenna is small enough to be compactly integrated into today's very small mobile communication devices. In addition, the antenna can operate on multiple frequency bands in both the retracted position and in the extended position, thereby providing a versatile single antenna solution for multiple band transceivers.

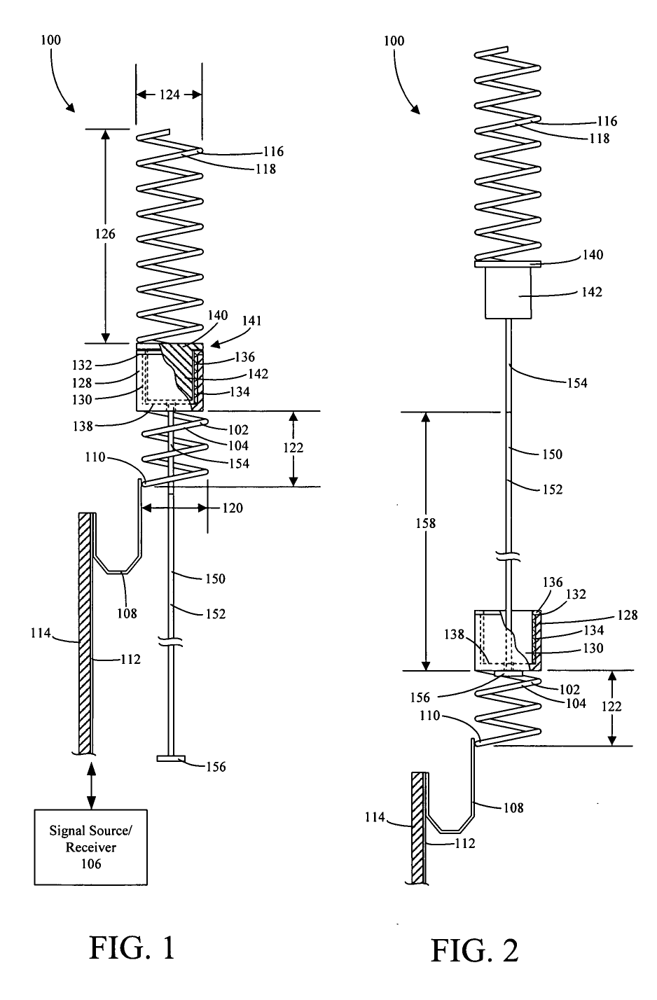

FIG. 1 depicts a side view a retractable antenna 100 in a retracted position. FIG. 2 depicts the antenna 100 in an extended position. Making reference both to FIG. 1 and to FIG. 2, the antenna can include a first helical radiator 102 that comprises a helically wound electrical conductor 104. The first helical radiator 102 can be communicatively linked to a signal source and/or a signal receiver 106. For instance, a contact 108 can be electrically connected to a first portion 110 of the first helical radiator 102 to provide electrical continuity with one or more circuit traces 112 on a printed circuit board 114 to which the source/receiver 106 is communicatively linked.

The antenna 100 also can include a second helical radiator 116 that comprises a helically wound electrical conductor 1 18. The first helical radiator 102 and the second helical radiator 116 can be substantially helically shaped, as shown in FIGS. 1 and 2. However, the invention is not so limited. For example, the first helical radiator 102 can have a modified helical shape in which the diameter 120 progressively changes along a length 122 of the helical radiator 102. Similarly, the second helical radiator 116 also can have a diameter 124 that progressively changes along its length 126. Still, other modifications to the helix shape can be made in one or both the helical radiators 102, 116, and such modifications are within the scope of the present invention.

The first helical radiator 102 can be electrically connected to a first coupling 128. A cup shaped cavity 130 can be defined in the coupling 128, extending inward from a first end 132 of the coupling 128. A dielectric insulator 136 can line an inner wall 134 of the cavity 130 and the first end 132 of the coupling 128. Optionally, the dielectric insulator 136 also can line a wall 138 of the cavity 130.

The second helical radiator 116 can be electrically connected to a second coupling 140. The second coupling 140 can engage the first coupling 128, as shown in FIG. 1, to form a capacitive coupler 141. For example, the second coupling 140 can have a lower portion 142 which may insert into the cavity 130. The dielectric insulator 136 can prevent the first and second couplings 128, 140 from electrically shorting. The dielectric insulator 136 can be formed of a dielectric material selected to have a dielectric constant (∈ᵣ) that provides a desired value of capacitance between the first and second couplings 128, 140. Such dielectric materials are known to the skilled artisan.

The capacitance between the first and second couplings 128, 140 can couple the first and second helical radiators 102, 116 for operation in half-wave mode. Additional electrical components (not shown) can be coupled along the electrical path between the signal source/receiver 106 and the antenna 100 to tune the antenna's resonant frequency and to tune the net impedance of the antenna 100. For example, resistors, capacitors and/or inductors can be communicatively linked between the signal source/receiver 106 and the antenna 100 to tune the antenna to have a half-wave resonance at 1.8 GHz with an impedance at that frequency of 50 ohms. The electrical components also can be used to tune the antenna's quarter-wave resonance characteristics. In addition, transmission line matching techniques can be used to adjust the impedance and/or the resonant frequencies of the antenna 100. The electrical components and/or impedance line matching techniques also can be implemented to achieve a low VSWR in the operating frequency bands. Notably, the combination of maintaining low VSWR while also operating the antenna 100 in half-wave mode can result in a low SAR which, advantageously, provides exceptional transmission/receive efficiency.

The lengths 122, 126 and diameters 120, 124 of the respective helical radiators 102, 116 can be selected to achieve a desired electrical length. For instance, the coupled first and second helical radiators 102, 116 can present an electrical length that is one-half the wavelength of a first operating frequency, thereby enhancing the transmission and receive performance of the antenna 100 even further. In comparison to quarter-wave antenna operation, operation as a half-wave antenna can have the desirable effect of maximizing transmission currents in the antenna, while minimizing transmission currents in the printed circuit board 114.

Notwithstanding that antenna operation in half-wave mode is desirable, the electrical length of the antenna also can be one-quarter the wavelength of a second operating frequency. For example, if the first operating frequency at which the antenna is tuned to operate in half-wave mode is 1.8 GHz, the antenna can operate in quarter-wave mode at 900 MHz.

The antenna 100 also can include a whip 150. The whip 150 can comprise an electrically conductive member (hereinafter “conductive member”) 152, a dielectric member 154 and a stop member 156. The stop member 156 can be electrically conducive and electrically contact the conductive member 152. The dielectric member 154 can minimize the influence of the whip 150 on the performance of the antenna 100 when the antenna 100 is in the retracted position shown in FIG. 1.

When the antenna 100 is in the extended position, as shown in FIG. 2, the stop member 156 can electrically contact the first coupling 128 to form a continuous electrical path between the conductive member 152, the stop member 156, the first coupling 128 and the first helical radiator 102. In the extended position, the primary transmission/receive components of the antenna can be the first helical radiator 102 and the conductive member 152. The dielectric member 154 can minimize the influence of the second helical radiator 116 on the transmission/receive characteristics of the antenna 100 when the antenna 100 is in the extended position.

Use of the antenna 100 in the extended position can improve antenna efficiency even further. As with operation in the retracted position, the antenna 100 also can efficiently operate in the extended position at a first frequency in which the antenna 100 is tuned for operation half-wave mode and at a second frequency in which the antenna 100 is tuned for operation in quarter-wave mode. For example, a length 122 of the first helical radiator 102 can be selected achieve a quarter-wave resonance at the first frequency. A length 158 of the conductive member 152 then can be selected to cooperate with the helical radiator 102 to achieve a half-wave resonance at the second frequency. Again, electrical components coupled along the electrical path can be used to tune the antenna's resonant frequencies and to tune the net impedance of the antenna 100 in the respective frequency bands.

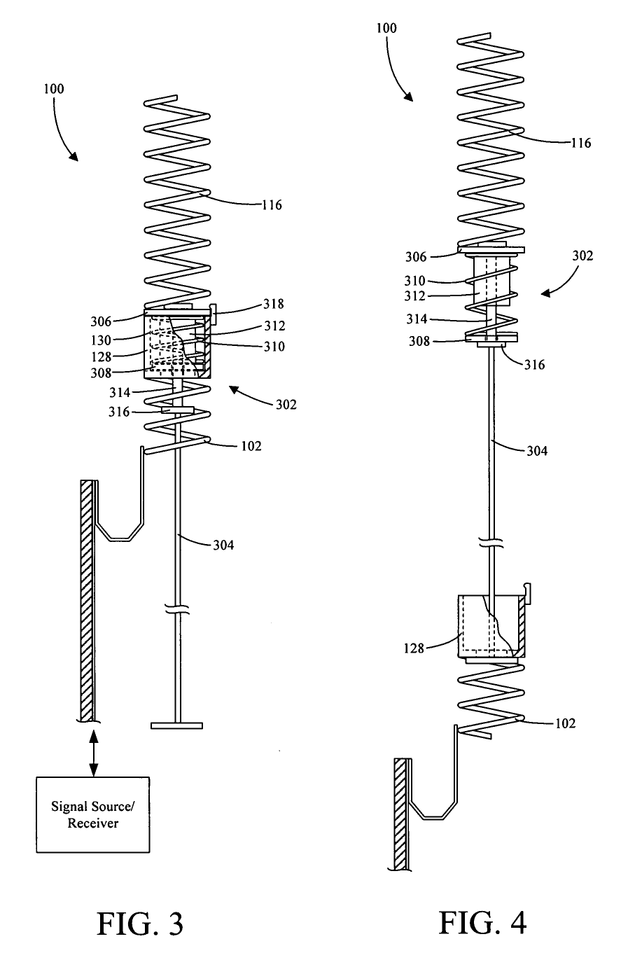

Another arrangement of the antenna 100 is depicted in FIGS. 3 and 4. In this arrangement a switch 302 can be provided to electrically connect and disconnect an electrically conductive whip 304 to the second helical radiator 116. In particular, the switch 302 can dielectrically insulate the whip 304 from the second helical radiator 116 when the antenna 100 is in the retracted position shown in FIG. 3, and the switch 302 can electrically connect the whip 304 to the second helical radiator 116 when the antenna 100 is in the extended position shown in FIG. 4. Accordingly, the whip 304 can be removed from the electrical circuit of the antenna 100 when the antenna 100 is in the retracted position, and placed in the electrical circuit when the antenna is in the extended position.

The switch 302 can comprise a first conductive plate 306, a second conductive plate 308, a conductive spring 310, stop member 312, a dielectrically insulated shaft 314 and a conductive whip contact 316. The whip contact 316 can electrically contact the whip 304 in a position that is fixed with respect to the whip 304.

In the retracted position shown in FIG. 3, the switch 302 can be inserted into the cavity 130 of the first coupling 128. The conductive spring 310 can compress, enabling the shaft 314 to extend the whip contact member 316 away from the second conductive plate 308 to break the electrical contact between the whip contact 316 and the second conductive plate 308. One or more flanges 318 can be provided to secure the switch 302 within the cavity 130.

In one arrangement the first conductive plate 306 and/or the second conductive plate 308 can electrically contact the first coupling 128 to form a continuous electrical path between the first helical radiator 102 and the second helical radiator 116. In another arrangement, a dielectric insulator (not shown) can be provided to insulate the first conductive plate 306 and the second conductive plate 308 from the first coupling 128. In this arrangement, the switch 302 can capacitively couple to the first coupling 128.

In the extended position shown in FIG. 4, the spring member 310 can expand to cause the second conductive plate 308 to engage the whip contact 316, thus creating an electrical connection between the conductive plate 308 and the whip contact 316. Accordingly, the first helical radiator 102, the whip 304, the second conductive plate 308, the spring member 310, the first conductive plate 306 and the second helical radiator 116 can create a continuous electrical path and form the primary transmission/receive components of the antenna 100.

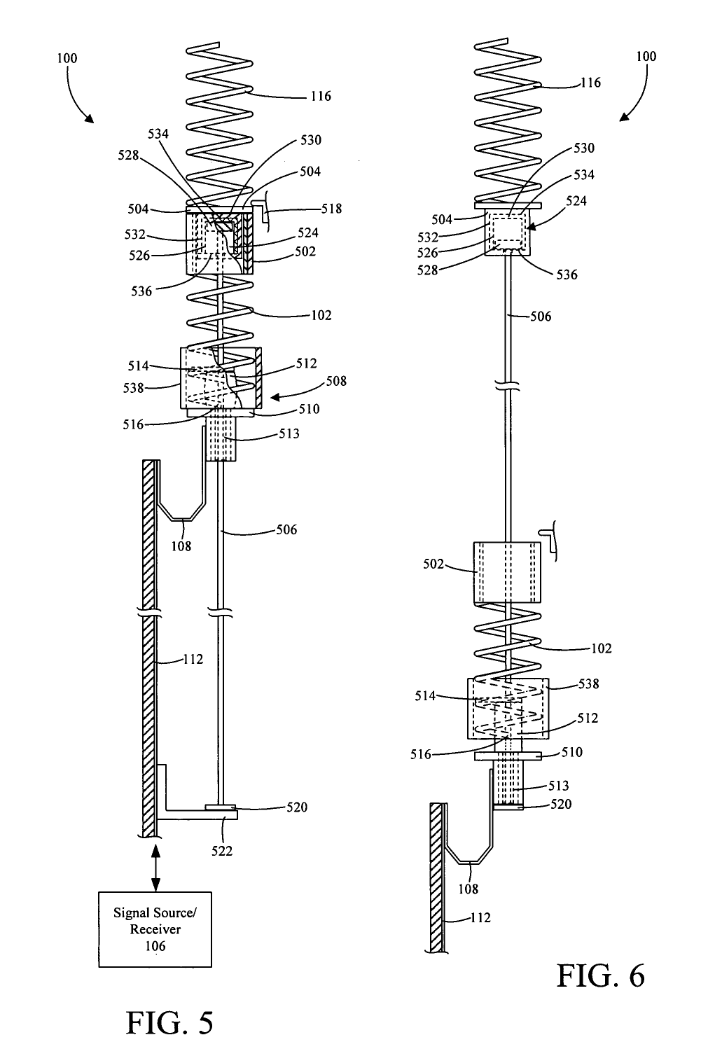

Another arrangement of the antenna 100 is depicted in FIGS. 5 and 6. In the retracted position shown in FIG. 5, the first helical radiator 102 and the second helical radiator 116 can be capacitively coupled via a first coupling 502 and a second coupling 504 in a manner similar to that previously described. In this position, the first helical radiator 102 and the second helical radiator 116 can comprise the primary radiating members of the antenna 100.

When the antenna 100 is in the extended mode shown in FIG. 6, the first helical radiator 102 can be electrically disconnected from the circuit 112, while the whip 506 is electrically connected to the second helical radiator 116 and the contact 108. Thus, in the extended position, the whip 506 and second helical radiator 116 can comprise the primary radiating members of the antenna 100.

A first switch 508 can electrically connect the first radiating member 102 to a conductive member 510 that provides an electrical connection to the contact 108. The first switch 508 can include, for example, a resiliently biased dielectric spring member 512 that is connected to the first helical radiator 102, for instance via a bracket 514. The spring member 512 can compress when the antenna 100 is retracted to enable a lower portion 516 of the first helical radiator 102 to contact the conductive member 510. A latch 518 can be provided to maintain the antenna 100 in the retracted position. Such latches are known to the skilled artisan. When the antenna 100 is disposed in the extended position, the spring member 512 can expand to disconnect the lower portion 516 of the first helical radiator 102 from the conductive member 510, which disconnects first helical radiator 102 from the signal source/receiver 106.

The conductive member 510 can be T-shaped, as shown, although the invention is not limited in this regard. Indeed, the conductive member 510 can be any shape suitable for providing an electrical connection to the first helical radiator 102. A dielectric member 513 that slideably engages the whip 506 can dielectrically insulate the whip 506 from the conductive member 506 when the antenna 100 is in the retracted position.

The whip 506 can comprise a first conductive stop member 520. In the retracted position, the first stop member 520 can engage a stop bracket 522, which can unidirectionally limit linear movement of the whip 506. In the extended position, the stop member 520 can engage the conductive member 510 to form an electrical contact between the whip 506 and the conductive member 510.

A second switch 524 can be provided within the second coupling 504 to electrically disconnect the whip 506 from the second coupling 504 when the antenna 100 is in the retracted position, and electrically connect the whip 506 to the second coupling 504 when the whip is in the extended position. For example, the switch can define a cavity 526 within which a second conductive stop member 528 electrically connected to the whip 506 is slideably disposed. A dielectric liner 530 lining a sidewall 532 and first end wall 534 of the cavity 526 can insulate the second stop member 528 from the second coupling 504 when the antenna 100 is retracted. However, when the antenna 100 is extended, the second stop member 528 can make electrical contact with a second end wall 536 of the cavity, thereby creating a continuous electrical connection between the second helical radiator 116, the whip 506, the conductive member 510 and the contact 108.

In one arrangement, an impedance tuning member 538 can be electromagnetically coupled to the first helical radiator 102 and/or coupled to the second helical radiator 116. The tuning member 538 can comprise a material selected to result in desired impedance characteristics for the first helical radiator 102 and/or the second helical radiator 116. For example, the tuning member 538 can comprise a ferromagnetic or metallic material. In addition, dimensions of the tuning member 538 also can be selected to achieve desired impedance characteristics for the first helical radiator 102 and/or the second helical radiator 116.

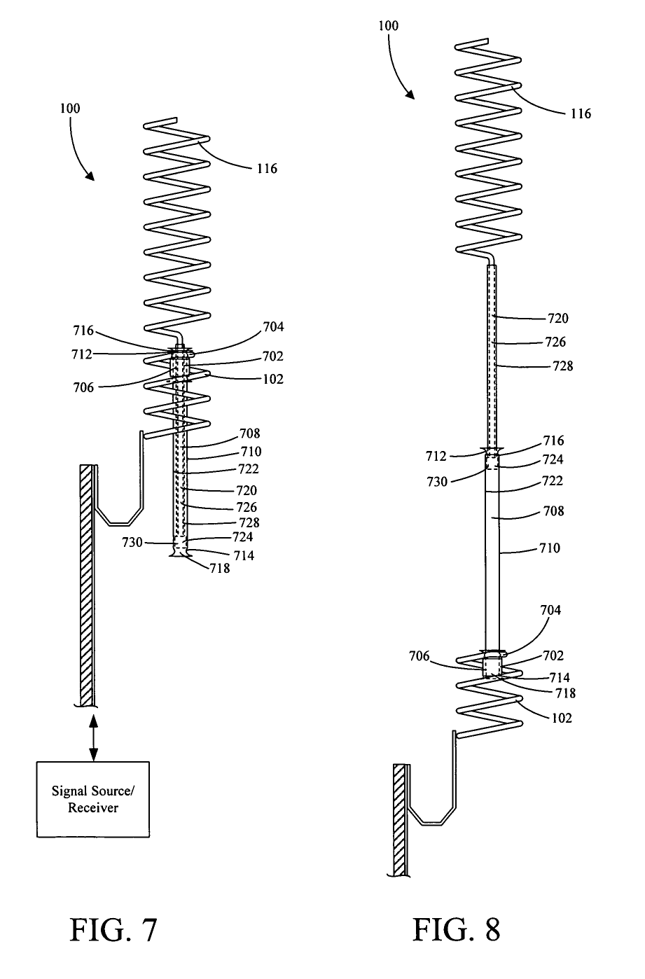

FIGS. 7 and 8 present yet another arrangement of the antenna 100. In this arrangement the first helical radiator 102 and the second helical radiator 116 can be electrically connected to each other both in the retracted position shown in FIG. 7 and in the extended position shown in FIG. 8. In addition, the distance of the electrical path between the first helical radiator 102 and the second helical radiator 116 can be approximately the same in both the retracted and extended positions.

The antenna 100 can include an electrically conductive slide bushing 702 connected to a second portion 704 of the first helical radiator 102. The slide bushing 702 can define a cavity 706 through which a first whip 708 slidably engages the slide bushing 702. The first whip 708 can comprise an electrically conductive external surface 710 such that the first whip 708 is in electrical contact with the slide bushing 702. Flanges 712, 714 can be formed at respective opposing ends 716, 718 of the first whip 708. The flanges 712, 714 can limit movement of the first whip 708 to a first position in which the flange 712 engages the slide bushing 702, as shown in FIG. 7, and to a second position in which the flange 714 engages the slide bushing 702, as shown in FIG. 8.

A second whip 720 can slidably engage an inner surface 722 of the first whip 708. The second whip 720 can comprise a conductor 726 and a stop member 724. The stop member 724 can limit movement of the second whip 720 to a first position in which the stop member 724 engages the flange 714 of the first whip 708 (see FIG. 7) and to a second position in which the stop member 724 engages the flange 712 of the first whip 708 (see FIG. 8).

The second whip 720 can comprise a dielectric sheath 728 that insulates the conductor 726 from the first whip 708. The stop member 724 and the inner surface 722 of the first whip 708 both can be electrically conductive, however, thus forming an electrical contact between the first whip 708 and the second whip 720. In this arrangement, the electrical contact between the first whip 708 and the second whip 720 can be limited to the area 730 where the stop member 724 engages the inner surface 722 of the first whip 708. Thus, when the antenna is in the retracted position shown in FIG. 7, the stop member 724 can provide an electrical connection between the first whip 708 and the first end 714 of the second whip 720. When the antenna is in the extended position shown in FIG. 8, the stop member 724 can provide an electrical connection between the first whip 708 and the second end 716 of the second whip 720. Thus, whether the antenna 100 is retracted or extended, the length of the electrical path between the first radiating member 102 and the second radiating member 116 is approximately the same.

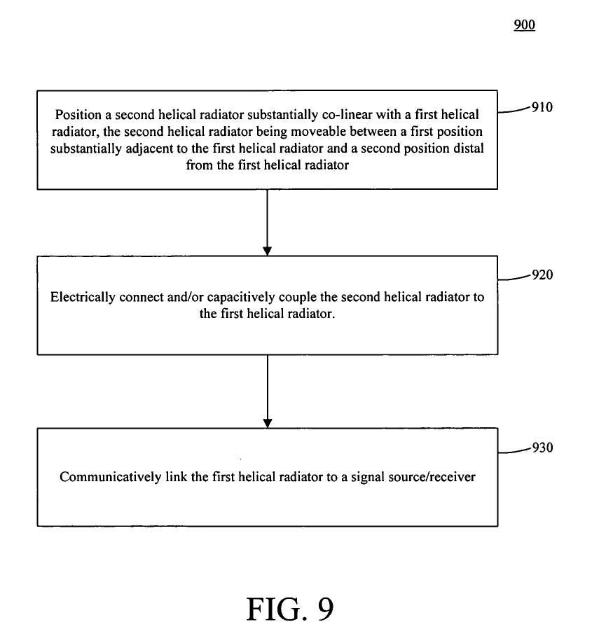

FIG. 9 is a flowchart that presents a method 900 useful for understanding the present invention. Beginning at step 910, a second helical radiator can be positioned substantially co-linear with a first helical radiator such that the second helical radiator is moveable between a first position substantially adjacent to the first helical radiator and a second position distal from the first helical radiator. At step 920, the second helical radiator can be electrically connected and/or capacitively coupled to the first helical radiator. At step 930, the first helical radiator can be communicatively linked to a signal source/receiver

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily through a conductive path, and not necessarily mechanically, e.g. linked through an electromagnetic field. The term electrically connected, as used herein, is defined as being connected via a continuously electrically conductive path (i.e. a path that, relative to the devices being connected, has low DC resistance). The term communicatively linked, as used herein, is defined as being linked via a signal path. The signal path can be a direct electrical connection having low DC resistance, but is not limited in this regard. For instance, a signal path also can comprise series components, such as capacitors, that impede or block DC current while propagating RF signals.

This invention can be embodied in other forms without departing from the spirit or essential attributes thereof. Accordingly, reference should be made to the following claims, rather than to the foregoing specification, as indicating the scope of the invention.

What is claimed is:

1. An antenna comprising:
a first helical radiator; and
a second helical radiator positioned substantially co-linear with the first helical radiator, the second helical radiator being moveable between a first position wherein the second helical radiator is substantially adjacent to the first helical radiator, and a second position wherein the second helical radiator is distal from the first helical radiator;
wherein the first helical radiator and the second helical radiator cooperate to transmit or receive electromagnetic signals using at least one link selected from the group consisting of an electrical connection and electromagnetic coupling.

2. The antenna of claim 1, further comprising a whip to which the second helical radiator is attached.

3. The antenna of claim 2, wherein the whip electrically connects the second helical radiator to the first helical radiator.

4. The antenna of claim 1, wherein the second helical radiator is electromagnetically coupled to the first helical radiator when the second helical radiator is in the first position and the second helical radiator is electrically connected to the first helical radiator when the second helical radiator is in the second position.

5. The antenna of claim 1, wherein the second helical radiator is electrically connected to the first helical radiator when the second helical radiator is in the first position and the second helical radiator is electrically connected to the first helical radiator when the second helical radiator is in the second position.

6. The antenna of claim 1, wherein the electromagnetic coupling primarily comprises capacitive coupling.

7. The antenna of claim 1, wherein the first helical radiator is communicatively linked to a signal source.

8. The antenna of claim 1, wherein the first helical radiator is communicatively linked to a signal source when the second helical radiator is in the first position, and the first helical radiator is not communicatively linked to the signal source when the second helical radiator is in the second position.

9. The antenna of claim 1, further comprising an impedance tuning member which electromagnetically couples to at least one antenna component selected from the group consisting of the first helical radiator and the second helical radiator.

10. An antenna comprising:
a first helical radiator;
a second helical radiator; and
a coupler that capacitively couples the first helical radiator to the second helical radiator;
wherein the first helical radiator and the second helical radiator cooperate to transmit or receive electromagnetic signals.

11. The antenna of claim 10, wherein the second helical radiator is positioned adjacent to the first helical radiator and is substantially co-linear with the first helical radiator.

12. The antenna of claim 10, wherein the second helical radiator is moveable between a first position wherein the second helical radiator is substantially adjacent to the first helical radiator, and a second position wherein the second helical radiator is distal from the first helical radiator.

13. The antenna of claim 12, wherein the first helical radiator is communicatively linked to a signal source when the second helical radiator is in the first position, and the first helical radiator is not communicatively linked to the signal source when the second helical radiator is in the second position.

14. The antenna of claim 12, wherein the first helical radiator and the second helical radiator are capacitively coupled when the second helical radiator is in a first position, and the first helical radiator and the second helical radiator are electrically connected when the second helical radiator is in a second position.

15. The antenna of claim 12, further comprising a whip to which the second helical radiator is attached.

16. The antenna of claim 10, further comprising an impedance tuning member which electromagnetically couples to at least one antenna component selected from the group consisting of the first helical radiator and the second helical radiator.

17. A method for tuning performance characteristics of an antenna comprising:
positioning a second helical radiator substantially co-linear with a first helical radiator such that the second helical radiator is moveable between a first position wherein the second helical radiator is substantially adjacent to the first helical radiator, and a second position wherein the second helical radiator is distal from the first helical radiator;
wherein the first helical radiator and the second helical radiator cooperate to transmit or receive electromagnetic signals using at least one link selected from the group consisting of an electrical connection and electromagnetic coupling.

18. The method according to claim 17, further comprising capacitively coupling the second helical radiator to the first helical radiator when the second helical radiator is in a first position.

19. The method according to claim 17, further comprising communicatively linking the first helical radiator to a signal source, wherein the second helical radiator is not communicatively linked to the signal source when the second helical radiator is in a first position, and the second helical radiator is communicatively linked to the signal source when the second helical radiator is in a second position.

20. The method according to claim 17, further comprising communicatively linking the first helical radiator to a signal source, wherein the second helical radiator is communicatively linked to the signal source when the second helical radiator is in the first position, and the second helical radiator communicatively linked to the signal source when the second helical radiator is in the second position.
